(19) United States
(12) Patent Application Publication
(10) Pub. No.: US 2018/0018305 A1
(43) Pub. Date: Jan. 18, 2018

(54) CHARACTER SPACING ADJUSTMENT OF TEXT COLUMNS

(71) Applicant: Hewlett-Packard Development Company, L.P., Fort Collins, CO (US)

(72) Inventors: Tamir Hassan, Vienna (AT); damera Venkata Niranjan, Chennai (IN)

(21) Appl. No.: 15/545,711

(22) PCT Filed: Feb. 5, 2015
(86) PCT No.: PCT/IN2015/000071

§ 371 Date: Jul. 23, 2017

(51) Int. Cl. G06F 17/21; G06F 17/22; G06F 17/25

(52) U.S. Cl. CPC G06F 17/212; G06F 17/25; G06F 17/2247; G06F 17/214

(57) ABSTRACT

An example device in accordance with an aspect of the present disclosure includes a rendering engine and a spacing engine. The rendering engine is to render, off-screen, a text column. The spacing engine is to adjust character spacing of the text column, to identify a loosest value of character spacing to fit the text column into an allocated width without introducing an additional line break to the text column.

### BACKGROUND

Print-oriented documents, such as Portable Document Format (PDF) files, are viewable using a plugin or external application. Such document viewers or plugins can distract the user, by interrupting the use of a present application (such as a web application) to switch focus to the document viewer (e.g., for print preview). Furthermore, such document viewers may inhibit user interaction (such as annotation, selection, sharing, etc.) with the document.

### BRIEF DESCRIPTION OF THE DRAWINGS/FIGURES

FIG. 1 is a block diagram of a device including a rendering engine and a spacing engine according to an example.

FIG. 2 is a block diagram of a system including rendering instructions and spacing instructions according to an example.

FIG. 3 is a diagram of text columns including character spacing and word spacing according to examples.

FIG. 4 is a diagram of text columns including character spacing and word spacing according to examples.

FIG. 5 is a flow chart based on adjusting character spacing according to an example.

FIG. 6 is a flow chart based on adjusting character spacing according to an example.

### DETAILED DESCRIPTION

Displaying characters at screen sizes to match specific dimensions can be challenging. A character (font) rendering engine may impose non-continuous variation of font sizes, resulting in the text likely being too small or too large to fit in an allocated space. Differences between rendering engines can cause variations in width for text of a given height, such as between choices of web browser, operating system, computing system configuration (e.g., operating system), and so on. Font rendering algorithms may rely on hinting instructions to adjust the shape (and widths) of the font characters, in an attempt to fit a given pixel grid to improve appearance, thereby causing further divergence from a font's natural width as printed or displayed on-screen, e.g.,, for a print preview or other zoomable presentation of text where the appearance of the page would be negatively affected. Thus, in an example, printing a given column, paragraph, and/or page of text may result in wasted page(s) of paper printout, where even a single line of text may spill-over unexpectedly to an extra last page, due to the print preview failing to accurately depict the text overflowing to the last page.

Examples described herein may adjust character spacing and/or word spacing quickly and efficiently, to enable text to fit particularly well in an allocated space, with an adjustable granularity finer than that offered by font size adjustments or other techniques. Thus, examples may improve readability and aesthetic quality of the text. There is no need to rely on pre-rendered static images of text to fit a given allocated space, or use a heavy-weight, server side algorithm to laboriously calculate the positions of individual characters.

Example systems and techniques described herein, enable character spacing and/or word spacing values to be calculated for an entire page efficiently, thereby enabling such high quality rendition techniques to effectively be carried out quickly, even on clients with limited processing power (e.g., mobile web browsing devices). Examples may avoid layout and/or character spacing errors of other approaches, by, e.g., identifying optimal values for character spacing that can average out rounding errors and hinting differences that may arise when rendering text at pixel sizes that differ from those of the initial layout (e.g., when zooming a text view to fill a screen width). Examples described herein may achieve subpixel text positioning for accurate Web-based print preview using a web browser, including shifting the horizontal position of characters by minute amounts to make text more readable. Examples may display text on a browser in such a way that, despite differing characteristics at significantly different pixel sizes, ensures that the text can occupy exactly a predetermined amount of space. Various features, thereby can enable features such as high-quality print previews of print-oriented documents in a Web interface. For example, a HyperText Markup Language (HTML) preview may be generated that appears visually identical to a PDF source document. The optimal value for character spacing may be chosen on a line-by-line and/or page-wide scale, e.g., by rendering off-screen for client-side document (e.g., PDF) viewing in the browser using native HTML. The displayed text is compatible with interactive interfaces, customizable for the application's needs (e.g. annotation, selection of content, sharing, integration in social media) including providing a refiowable document for the screen or mobile device (tablet, smartphone, etc.). Thus, the user experience may be seamless within a given application, without a need to take the user away from the application to view a document in a separate dedicated document viewer, while enjoying visually pleasing text layout.

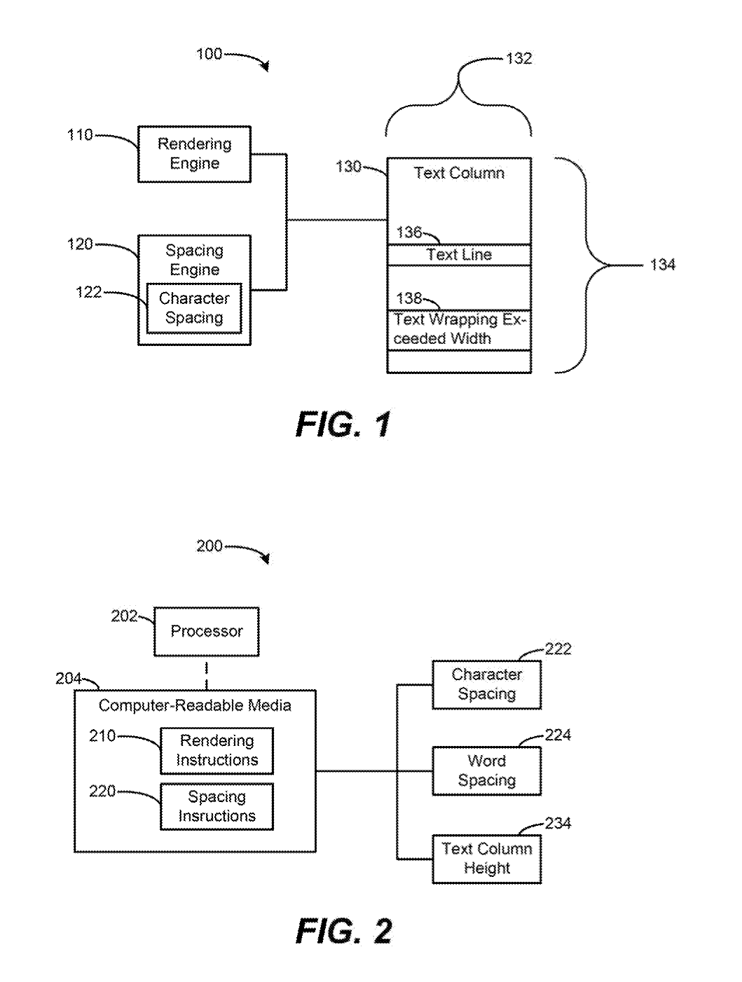

FIG. 1 is a block diagram of a device 100 including a rendering engine 110 and a spacing engine 120 according to an example. The rendering engine 110 and the spacing engine 120 are associated with text column 130 and character spacing 122. The text column 130 includes a text line 136, and illustrates text wrapping 138. The text column 130 is associated with a width 132 and a height 134.

System 100 enables the rendering engine 110 and spacing engine 120 to, e.g., map text from PDF to HTML or vice versa, so that line breaks do not change between formats. For example, a line break establishing text line 136 in a text source, will be preserved at the same points in text output destination. Similarly, column breaks may be preserved to maintain the characteristics of the text column 130 in the text output destination. While preserving the line and/or column breaks in the text column 130, the spacing engine 120 is to adjust character spacing 122, allowing for some movement of the text within a given text line 136 of the text column 130. Thus, global consistency of text layout may be maintained when rendering (e.g., converting, translating, resiting, zooming, etc.) text, particularly between formats. Accordingly, the rendering engine 110 and spacing engine 120 may prevent a given text line 136 from acquiring an additional line break due to exceeding the allocated width 132 of the text column 130. Such a situation is illustrated by text wrapping 138. If text is allowed to fall over to another line, the layout of the text column 130 can be affected negatively, due to the text reflow altering the source layout of the text column 130. For example, the additional line break in the text wrapping 138 can increase the text column height 134 compared to the height of the source text. The rendering engine 110 and the spacing engine 120 can ensure that such text reflow does not ripple through a text document including text column 130, because the engines 110, 120 may confine the movement of text of a given text line 136 within that text line 136 (an approach that may be applied to the various text lines comprising a text column 130) In an example, a character andior a word may be moved by a fraction of a pixel to for improved visual appearance and screen readability.

Generally, the engines 110, 120 may produce the text column 130 using character spacing 122 corresponding to a loosest value before the contents of individual text lines 136 no longer fit into the allocated text column width 132 (and potentially begin wrapping to the following line due to introduction of additional line break(s)). The value of the corresponding character spacing 122 may be determined for an entire text column 130 and/or text page, e.g., across the text contents of a given font, to provide a consistent rendition. Alternatively, character spacing 122 may be determined on a more localized basis, such as per text column 130 and even on a line-by-line basis.

The device 100 may determine such character spacing 122 very efficiently, as follows. The rendering engine 110 may render text as a single column off-screen. For example, the text column 130 may be rendered in the background, without being displayed on a screen, The text column 130 may be initially rendered using a default character spacing 122, such as that spacing designated by the text font at that particular pixel size as determined by the rendering engine being used. At this point, the device 100 does not need to check whether the text spacing is too loose or too tight for each individual line, avoiding time-consuming calculations and improving efficiency.

Next, the spacing engine 120 is to tighten character spacing by an increment For example, the spacing engine 120 may use a “just-noticeable difference” increment, e.g., according to a human visual system model and capabilities of the rendering engine 110 and/or size of a given pixel grid used to display the text. In some examples, the just-noticeable difference may correspond to an increment of 0.2 pixels. The spacing engine 120 is to incrementally tighten the character spacing until it reaches a lower limit, e.g., a predetermined amount of tightness in the character spacing 122 below a default character spacing. In an example, the lower limit may be −1.0 pixel (px), i.e., one pixel lower than the default character spacing for that font, At each increment of character spacing 122, the rendering engine 110 is to measure the off-screen rendered text column,height 134, i.e., compare the initial text column height 134 to the incrementally rendered text column height 134 for a given increment of character spacing 122. The system 100 may identify a reduction in text column height 134 as corresponding to one or more text lines 136 being reduced enough to fit into the allocated text column width 132. The lower limit (such as −1.0 px) may vary for given circumstances, and may be chosen to serve as a realistic lower limit to compensate for foreseeable character width changes. The lower limit may be empirically found for a particular font as needed. For example, iteratively reducing the lower limit until visual issuesianomalies arise (e.g., text character overlap and/or collisions rendering the text visually unappealing).

If a reduction in text column height 134 occurred as a result of the iterative tightening of the character spacing, the spacing engine 120 is to identify the loosest value of character spacing 122 corresponding a shortest text column height 134.

However, if a reduction in text column height 134 did not occur as a result of the iterative tightening, of the character spacing, the character spacing is reset to a standard character spacing value. The spacing engine 120 is to then identify that the character spacing 122 (as reset to the standard value) is either 1) set correctly, or 2) may be further loosened to improve appearance and readability. Accordingly, the spacing, engine 120 may incrementally loosen the character spacing 122 (e.g., by the just-noticeable difference) until the rendered text column height 134 (as rendered off-screen by the rendering engine 110) experiences an increase. The spacing engine 120 may then identify the optimum value of character spacing 122 as that incremental value of character spacing 122 just before the increase of the text column height 134 occurred.

The rendering engine 110 may perform rendering directly, and/or may direct an external rendering engine to perform the rendering. In an example, the rendering engine 110 is to direct a Web browser to render the text column 130, to efficiently check the entire text column 130 for line breaks. The rendering engine 110 may render the text column 130 as a collection of separate text lines 136, where a given text line 136 is to introduce an additional line break in response to that text line 136 exceeding the allocated text column width 132 (e.g., as illustrated by text wrapping 138 of a given text line). Accordingly, device 100 may efficiently enable checking of incremental values of character spacing 122 according to whether a given line has broken to the next line, by, checking the aggregate height of the text column 130 formed by the individual text lines 136.

Device 100 may adjust character spacing 122 for an entire text column 130, and/or on a line-by-line basis. Similarly, device 100 may apply text justification. Justifying the text may result in word spacing being adjusted, which may affect the appearance of text, particularly for those text lines 136 whose character spacing has been adjusted. Accordingly, word spacing as well as character spacing 122 may be varied to ensure visually appealing text. In an example, the spacing engine 120 may tighten the word spacing of a given text line 136 (or the entire text column 130) by a just-noticeable difference (e.g., tighten by 2 pixels), in response to character spacing 122 being set to a value that is tighter than standard. If the character spacing 122 is not set to a value that is tighter than standard, the spacing engine 120 may set the word spacing to the standard/default tightness (e.g., 0 pixels tighter/looser). The word spacing for justified text lines also may naturally adjust in response to changes in the character spacing 122, i.e., as gaps between words change in response to adjustment in the tightness and looseness of the letters.

In an example, the rendering engine 110 may direct a Web browser to render the text in JavaScript®, a common and widely-used standard for client-side scripting. In alternate examples, other languages/tools may be used, including a native rendering engine custom provided by the device 100, In an example, rendering engine 110 may render a paragraph of text according to the allocated text column width 132, by individually adding each text line 136 of the text column 130 to a <div> container (i.e., HTML division) having the allocated width, as a <p> object (i.e., HTML paragraph) in its own right. Justification for the object (i.e., the text line 136) may be set to full, e.g., by adding a blank line using the “::after” Cascading Style Sheet (CSS) selector. Word spacing for the object, may be tightened (e.g., iteratively by the just-noticeable difference for word spacing), allowing the width of the object to be reduced in cases where the layout is relatively tight. Accordingly, the device 100 may define a certain formatting for a particular container/text line 136, without affecting the rest of the containers or the entire document.

The allocated width 132 for the text column 130 and/or text lines 136 may be obtained from various sources based on various techniques. For example, a display screen may be 700 pixels wide. The width of a source PDF document may be read from its CSS information (e.g., CSS word spacing property), and that width may be translated into the allocated text column width 132. If the source document is seven inches wide, the text may be displayed at (700 pixels divided by seven inches=100 pixels per inch (ppi)). Regardless of whether a 100 ppi resolution would introduces anomalous character and word spacing, the present examples may adjust the character spacing to produce visually appealing text layout. A source document (such as a PDF, Open Extensible Markup Language (XML) Paper Specification (XPS), and so on) having a text column seven inches wide can be displayed on the screen having a 700 pixel width by using a resolution of 100 ppi, according to a geometric transformation between the physical coordinates of the source document and the pixel coordinates of the resulting text column 130. Similar translations may be used for scaling and zooming text according to user display preferences (e.g., for print preview on, a given device), while adjusting the character spacing for appealing text layout. Various technologies, such as, client-side frameworks including HTML, CSS, and JavaScript, may be used to obtain characteristics for and interact with the text column 130 and various attributes such as character spacing 122. Standardized parts of web browser rendering platforms may be controlled by the rendering engine 110 and/or the spacing engine 120 to achieve the desired appearance of the text column 130. Other rendering frameworks may be used, including DirectDraw, GNOME Toolkit (GTK), and the like.

Thus, examples enable the reproduction of a source document, such as a PDF, XPS, etc., having a fixed layout, in a format designed for more flexible, reflowable layout (such as HTML), ensuring that the fixed layout is maintained, with particular attention to readability and aesthetic quality, In some examples, an image-based format may be used as the source document, by performing text recognition to obtain the text, the font, and the start and end coordinates of text lines in the image document. The text-based format is useful for allowing richer interaction with the content, such as annotation, sharing, etc. Character spacing may be adjusted for increased layout accuracy compared to the source document, accommodating any variations in text rendering of a given Web browser in which the document is to be rendered. In an example, system 100 may be implemented in JavaScript® on the client-side, as a scalable solution. Example systems may be provided as part of a firmware of a user device such as a tablet, laptop, smartphone, and the like. System 100 also may be deployed on the server-side. For example, a server may be used to generate HTML code to be used on a client's Web browser. The server may customize the generated code to a client's particular environment including browser, screen configuration, and rendering system, in order to ensure a good result in appearance of the text column 130. For example, a server may pre-render an entire novel (e.g., several hundred pages) for consumption on a client device. A headless browser (e.g., a WebKit engine, PhantomJS, etc.) may run system 100 on the server-side. Examples may leverage core Web browser rendering functionality for quick and efficient operation, avoiding a need to switch to a dedicated document viewer application or plugin Adobe® Acrobat®). Results from device 100 may be integrated into a browser interface, enabling features such as embedding advertising or linking output with social networks and other uses.

Storage (not shown in FIG. 1) may be accessible by the device 100. to serve as a computer-readable repository to store information such as iterative and/or resultant values for character spacing 122 and text column 130 that may be referenced by the engines 110, 120 during their operations. As described herein, the term “engine” may include electronic circuitry for implementing functionality consistent with disclosed examples. For example, engines 110, 120 represent combinations of hardware devices (e.g., processor and/or memory) and programming to, implement the functionality consistent with disclosed implementations. In examples, the programming for the engines may be processor-executable instructions stored on a non-transitory machine-readable storage media, and the hardware for the engines may include a processing resource to execute those instructions. An example system (e.g., a computing device), such as device 100, may include and/or receive tangible non-transitory computer-readable media storing a set of computer-readable instructions. As used herein, processor/processing resource(s) may include one or a plurality of processors, such as in a parallel processing system, to execute the processor-executable instructions. The memory can include memory addressable by the processor for execution of computer-readable instructions. The computer-readable media can include volatile and/or non-volatile memory such as a random access memory (“RAM”), magnetic memory such as a hard disk, floppy disk, and/or tape memory, a solid state drive (“SSD”), flash memory, phase change memory, and so on.

In some examples, the functionality of engines 110, 120 may correspond to operations performed in response to, e.g., information from text column 130 as provided and/or received by the, e.g., engines 110, 120 and so on. Although functionality may be described in terms of a given engine 110, 120, such functionality is not so limited, and may be performed by either or both of the engine(s) 110 and/or 120 and/or provided by an engine or component not specifically illustrated (e.g, a component of a web browser of a computing system as set forth above), Storage may be accessible by the system 100 as a computer-readable storage media, in which to store items in a format that may be accessible by the engines 110, 120.

Examples described herein may be used in an on-demand printing program that enables users to print the content they choose from a given web page, while producing readable, aesthetically pleasing output free of layout errors. Examples enable a publication-quality print-on-demand service in JavaScript® running directly in the client's browser and/or in conjunction with a server run by the publisher that delivers documents to the client for previewing and printing. Print output may be previewed within the browser (allowing extension to mobile devices as well). Other examples may provide dual-format (print and Web) custom textbooks with browser-based interactive preview and drive printing, e.g., in educational applications.

FIG. 2 is a block diagram of a system 200 including rendering instructions 210 and spacing instructions 220 according to an example. The computing system 200 of FIG. 2 may also include a processor 202 and computer-readable media 204, associated with rendering instructions 210 and spacing instructions 220. The instructions 210, 220 may interface with information including character spacing 222, word spacing 224, and text column height 234. In some examples, operations performed when instructions 210, 220 are executed by processor 202 may correspond to the functionality of engines 110, 120 (FIG. 1). Thus, in FIG. 2, the operations performed when rendering instructions 210 are executed by processor 202 may correspond to functionality of rendering engine 110 (FIG. 1). Similarly, the operations performed when spacing instructions 220 are executed by processor 202 may correspond to functionality of spacing engine 120 (FIG. 1).

As set forth above with respect to FIG. 1, engines 110, 120 may include combinations of hardware and programming. Such components may be implemented in a number of fashions. For example, the programming may be processor-executable instructions stored on, tangible, non-transitory computer-readable media 204 and the hardware may include processor 202 for executing those instructions 210, 220. Processor 202 may, for example, include one or multiple processors. Such multiple processors may be integrated in a single device or distributed across devices. Media 204 may store program instructions, that when executed by processor 202, implement system 100 of FIG. 1. Media 204 may be integrated in the same device as processor 202, or it may be separate and accessible to that device and processor 202.

In some examples, program instructions can be part of an installation package that when installed can be executed by processor 202 to implement system 100. In this case, media 204 may be a portable media such as a CD, DVD, flash drive, or a memory maintained by a server from which the installation package can be downloaded and installed. In another example, the program instructions may be part of an application or applications already installed. Here, media 204 can include integrated memory such as a hard drive, solid state drive, or the like. While in FIG. 2, media 204 includes instructions 210, 220, one or more instructions may be located remotely from media 204. Conversely, although FIG. 2 illustrates information corresponding to character spacing 222, word spacing 224, and text column height 234 as being located separate from media 204, such information may be included with media 204.

The computer-readable media 204 may provide volatile storage, e.g., random access memory for execution of instructions. The computer-readable media 204 also may provide non-volatile storage, e.g., hard disk or solid state disk for storage. Components of FIG. 2 may be stored in any type of computer-readable media, whether volatile or non-volatile. Content stored on media 204 may include images, text, executable files, scripts, or other content that may be used by examples as set forth below. For example, media 204 may contain configuration information or other information that may be used by engines 110, 120 and/or instructions 210, 220 to provide control or other information.

The character spacing 222, word spacing 224, and/or text column height 234 may be determined by the rendering instructions 210 and/or spacing instructions 220 to translate a source document including source text to an output document including a text column. For example, a source, document (such as a PDF print format) may include text having fixed line breaks. However, changes in resolution between the source and output sizes may introduce challenges in scaling the text. Font rendering may cause text to scale non-proportionally or non-uniformly, affecting the widths of the characters and/or words. Merely stretching the text to fit a given text line may result in exceedingly loose spacing between words, and a text line may introduce additional line breaks causing the text line to break into multiple lines affecting the text column height 234. Thus, the system 200 may adjust the character spacing 222 and/or word spacing 224 to ensure that the line breaks in a text column are accurate, without introducing additional line breaks or otherwise negatively affecting the text column height 234.

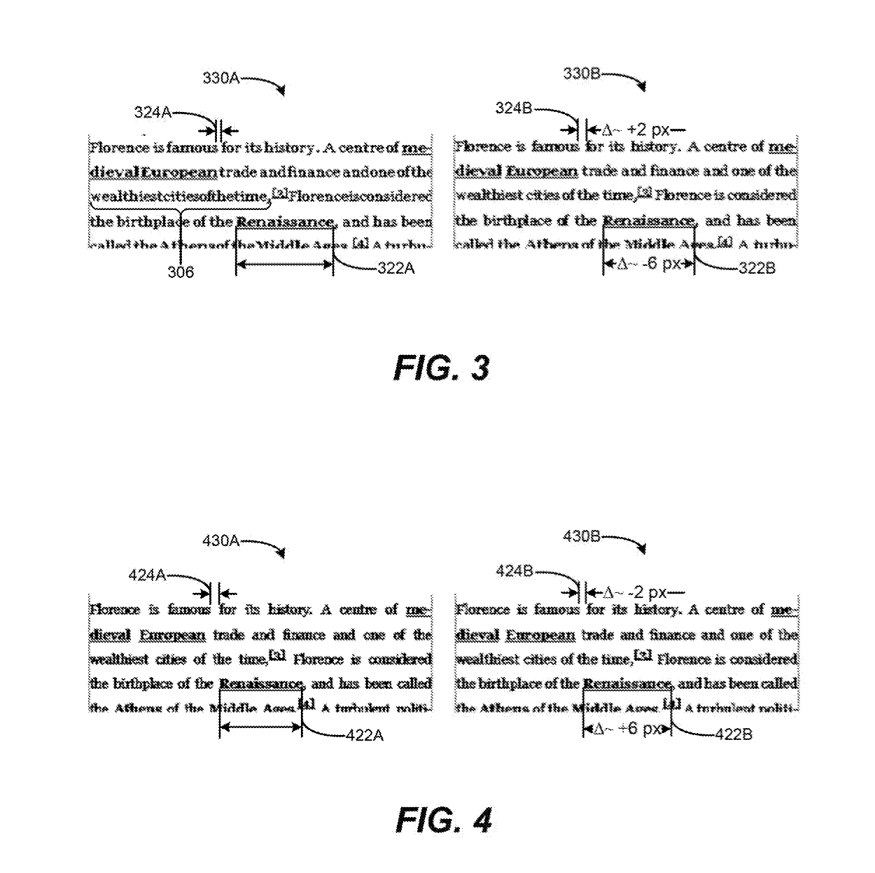

FIG. 3 is a diagram of text columns 330A, 330B including character spacing 322A, 3228 and word spacing 324A, 3248 according to examples. Text column 330A illustrates a type of rendering issue 306 (words running together), associated with given character spacing 322A and word spacing 324A, that may be avoided in the approach of text column 330B.

Text column 330A represents a paragraph of text being rendered in a given type of Web browser (e.g., the Chrome™ browser) running on the Windows® operating system, without character spacing adjustment or the various benefits provided by the examples described herein, For example, the text has been rendered using word spacing alone to justify the text column. Due to particularities of its rendering engine, the characters are rendered slightly wider than desired for the given text column 330A. This results in overly tight text because each word is slightly wider than standard (such that the words run into each other). Such anomalies may arise when the font and font size from a source document (e.g., PDF) are used, but the browser slightly deviates from the standards of that particular source document's font when rendering the text in HTML.

Such rendering issues may appear in HTML text due to the particularities of the Web browser (e.g., slightly wider characters), causing the displayed text column 330A to deviate in appearance from the source text (i.e., running words together as particularly noticeable as labeled at issue 306). Even if the Web browser uses the same font and font size as the source document, there is no guarantee in existing browser rendering approaches that the output text will take up exactly the same width as it does on the page, because of different resolutions between, e.g., a screen and printer. The example approaches and techniques described herein, however, can ensure that the issues shown in text column 330A are avoided, making it possible to accurately replicate, e.g., justified text from original (e.g., PDF) documents into output (e.g., HTML). Such example benefits therefore may compensate for any anomalies introduced by particularities of a given Web browser, by adjusting spacing efficiently.

Example devices and systems may direct a Web browser to position text at a granularity of pixel and even sub-pixel increments, according to the native rendering support offered by a given Web browser. Thus, examples may take advantage of a large range of devices to obtain optimal results. Examples may average adjustments to sub-pixel areas across an entire line of text. avoiding jagged character spacing in in any given text location (such as localized tight grouping of words, including issue 306).

Examples described herein enable fine granularity venation of character spacing (e.g., by adjusting a CSS attribute “letter-spacing”), to produce text column 330B. Merely varying font size would not enable such fine granularity, e.g., single and/or sub-pixel variation. By tightening the character spacing 322B in text column 330B, compared to character spacing 322A of text column 330A, free space is available between words for additional word spacing 324B. For example, due to the tighter character spacing 322B, the word Renaissance occupies approximately 6 fewer pixels. Accordingly, individual words in text lines are easily distinguishable (eliminating the issue 306).

Text column 330A also illustrates standard/default spacing that may be associated with a given font or text. The standard value is the character spacing and/or word spacing, per the font's definition, at which the font is usually rendered absent explicit instructions or additional information. In other words, a nominal, normal spacing for a given font. However, the examples described herein may use tighter (e.g., negative) and/or looser (e.g., positive) character spacing and/or word spacing. Tighter spacing can bring characters closer together than the default value, and looser spacing can move the characters farther apart than the default value. Examples can achieve such spacing in fractional pixel amounts, when using a rendering solution that supports sub-pixel/fractional variations. in situations without such rendering support, characters may be adjusted such that some characters are positioned one pixel closer together, and some characters one pixel farther apart, across a given text line (e.g., by distributing the average spacing across the line and rounding to the nearest pixel).

Character spacing and word spacing may be averaged across a text line. In an example to calculate a line spacing value, a CSS value may be used to ensure that spacing for the text line is averaged out well. The values for word spacing and character spacing for a given text line may be adjusted to ensure that the text remains readable. If default character spacing is too small, the character spacing may be loosened by a slight amount, to avoid degrading the appearance of the text by distributing the adjustment across the text line, If the default character spacing is too large, the character spacing may be tightened to distribute the difference across the text line. To identify the proper adjustment, the text column may be rendered off-screen using different incremental sets of spacing values. The various examples enable continuous variation in how tight or loose the character spacing and/or word spacing is set. Accordingly, it is possible to achieve spacing at fine granularities that are not available from merely adjusting font size, even when rounding the font size according to hinting to fit a given pixel grid.

FIG. 4 is a diagram of text columns 430A, 430B including character spacing 422A, 422B and word spacing 424A, 424B according to examples. Text column 430A illustrates a rendering issue (e.g., loose word spacing) that is not present in text column 430B.

Text column 430A represents a paragraph of text being rendered in the Firefox® Web browser on Windows, without character spacing adjustment. Due to particularities of its rendering engine, the default characters rendered by Firefox® are slightly tighter than desired, for the given text column 430A. This results in extremely loosely set text in Firefox® (such that the words are excessively spaced from each other).

Example text column 430B remedies the tight text/loose word spacing, and may be produced by varying the character spacing (e.g., CSS attribute “letter-spacing) at a granularity much finer than that available by merely adjusting the font size. By slightly increasing character spacing 422B in the example text column 430B, the large gaps between the words in text column 430A are reduced, thereby improving readability. As shown, the character spacing 422B used in text column 430B has increased the width of the sample word Renaissance by approximately six pixels. Notably, examples described herein do not need to exhaustively examine each individual text line, and may efficiently identify proper character spacing across an entire text column by rendering the column off screen. Accordingly, approaches described herein may run efficiently and quickly, even on client-side Web browsers of low-power devices.

Thus, FIGS. 3 and 4 illustrate two types of situations that may arise. Text column 330A of FIG. 3 illustrates character spacing that is too loose, crowding the words together. The issue is remedied in text column 330B by finding the least-tight character spacing to fit the text within a given text column width, and potentially adjusting word spacing as needed to allow for gaps between words due to the space freed up by the tighter text. The text column 430A illustrates character spacing that is too tight, causing excessive gaps between words. This situation is remedied in text column 430B by loosening the character spacing to enable the slightly wider words to better fill up the gaps between the words on a given text line. Such adjustments to character spacing and/or word spacing may be made in fine increments, such as just-noticeable differences at very fine granularities.

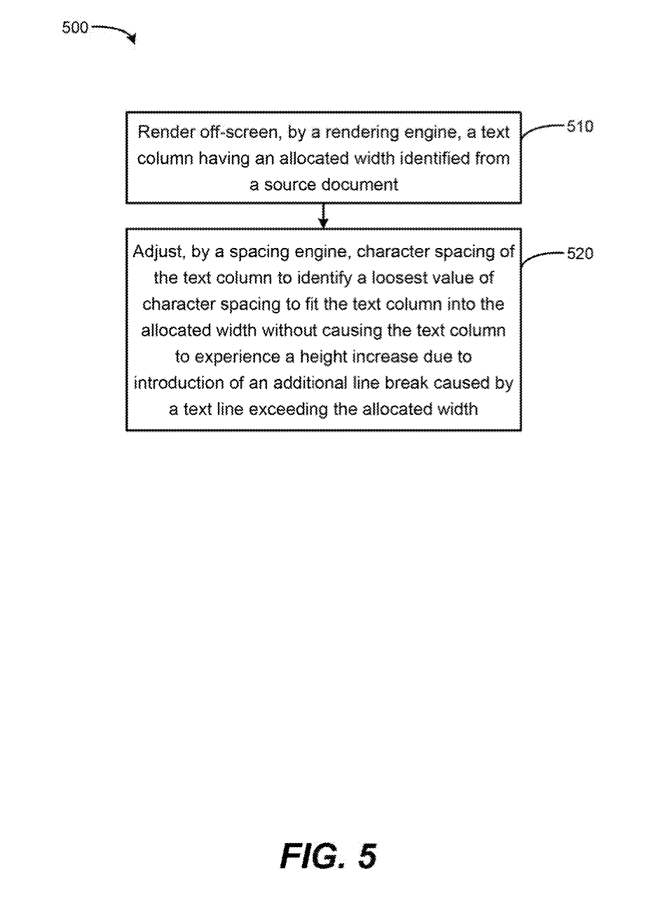

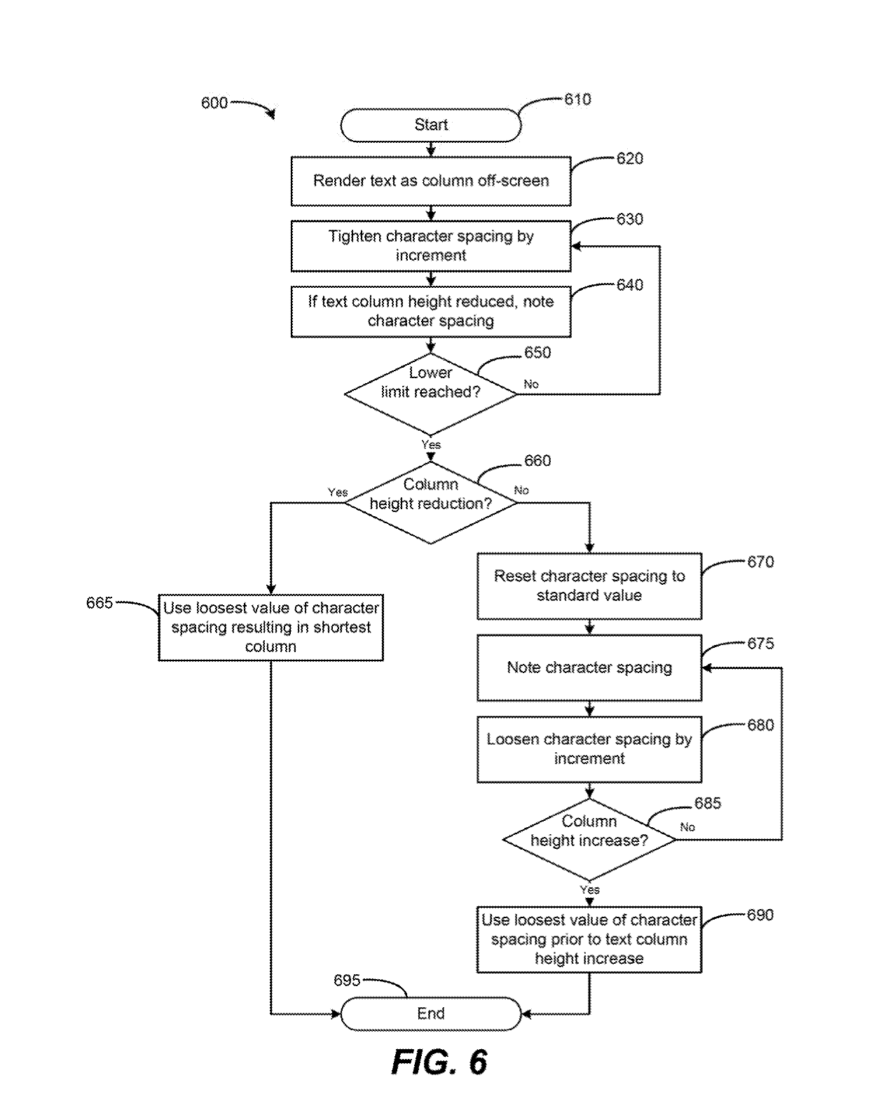

Referring to FIGS. 5 and 6, flow diagrams are illustrated in accordance with various examples of the present disclosure. The flow diagrams represent processes that may be utilized in conjunction with various systems and devices as discussed with reference to the preceding figures. While illustrated in a particular order, the disclosure is not intended to be so limited. Rather, it is expressly contemplated that various processes may occur in different orders and/or simultaneously with other processes than those illustrated.

FIG. 5 is a flow chart 500 based on adjusting character spacing according to an example. In block 510, a rendering engine is to render, off-screen, a text column having an allocated width identified from a source document. For example, when a given text line of the text column exceeds the allocated width due to spacing adjustments, an additional line break appears in that line, thereby causing the line to form two lines. In block 520, a spacing engine is to adjust character spacing of the text column to identify a loosest value of character spacing to fit the text column into the allocated width without causing the text column to experience a height increase due to introduction of an additional line break caused by a text line exceeding the allocated width. For example, the rendering engine can incrementally render the text column using the incrementally adjusted character spacing, while checking for changes in height to the text column.

FIG. 6 is a fiow chart 600 based on adjusting character spacing according to an example. Flow starts at block 610. In block 620, text is rendered as a column off-screen. For example, a rendering engine may direct a Web browser to render the text column at a standard/default character spacing. In block 630, character spacing is tightened by an increment. For example, the character spacing may be tightened by a just-noticeable amount. In block 640, if a reduction in text column height has occurred, the current character spacing is noted. For example, the rendering engine may check a height of the text column when rendered at the incrementally tightened character spacing, and if reduced, the incrementally tightened character spacing may be noted for future reference. In block 650, it is identified whether a lower limit of character spacing has been reached. For example, a lower limit may be identified corresponding to a given font, and the character spacing may be checked against that value at each incremental change of the character spacing. If the lower limit has not been reached (the “No” branch), flow loops back to block 630, where character spacing is again tightened by the increment. If at block 650 it is determined that a lower limit for character spacing has been reached (the “Yes” branch), flow proceeds to block 660. In block 660, it is identified whether a reduction in text column height has occurred. For example, whether tightened character spacing removes any additional line breaks to allow two text lines to fit on one line within the allocated text line width, If a reduction in text column height has occurred (the “Yes’ branch), flow proceeds to block 665. In block 665, the loosest value of character spacing, resulting in the shortest text column height, is used. For example, the value of character spacing as noted earlier is used. Following block 665, flow ends at block 695. If, at block 660, a reduction in text column height has not occurred (the “No” branch), flow proceeds to block 670. In block 670. character spacing is reset to the standard value. In block 675, the current character spacing is noted. For example, the incrementally tightened character spacing from block 640 may be stored for future reference. In block 680, character spacing is loosened by an increment. For example, the character spacing may be increased by a just-noticeable sub-pixel increment, In block 685, it is identified whether an increase in text column height has occurred. For example, the text column may be rendered off-screen to check, in the aggregate as a collection of text lines, whether the total height of the text column has changed. If a text column height increase has not occurred (the “No” branch), flow loops back to block 675, where current character spacing is again noted and subsequently loosened. If, at block 685, an increase in text column height has occurred (the “Yes” branch), flow proceeds to block 690. In block 690, the loosest value of character spacing, prior to an increase in text column height occurring, is used. For example, in response to the height increase, the noted character spacing from block 675 (i.e., prior to the character spacing adjustment) may be used. Flow ends at block 695.

Examples provided herein may be implemented in hardware, programming, or a combination of both. Example systems can include a processor and memory resources for executing instructions stored in a tangible non-transitory computer-readable media (e.g., volatile memory, non-volatile memory, and/or computer-readable media). Non-transitory computer-readable media can be tangible and have computer-readable instructions stored thereon that are executable by a processor to implement examples according to the present disclosure. The term “engine as used herein may include electronic circuitry for implementing functionality consistent with disclosed examples. For example, engines 110-130 of FIG. 1 may represent combinations of hardware devices and programming to implement the functionality consistent with disclosed implementations. In some examples, the functionality of engines may correspond to operations performed by user actions, such as selecting steps to be executed by processor 202 (described above with respect to FIG. 2).

What is claimed is:

1. A device comprising:
a rendering engine to render, off-screen, a text column having an allocated width, wherein the text column is to experience a height increase in response to introduction of an additional line break caused by a text line exceeding the allocated width; and
a spacing engine to adjust character spacing of the text column, at a pixel granularity finer than that available from font character size adjustments, to identify a loosest value of character spacing to fit the text column into the allocated width without introducing an additional line break to the text column.

2. The device of claim 1, wherein, in response to the spacing engine incrementally adjusting the character spacing, the rendering engine is to render the text column off-screen to identify the text column height.

3. The device of claim 1, wherein the spacing engine is to incrementally adjust character spacing in increments corresponding to a just-noticeable difference.

4. The device of claim 1, wherein the spacing engine is to tighten the word spacing in response to the character spacing being set to a tighter value than standard character spacing, and the spacing engine is to set the word spacing to a standard value in response to the character spacing being set to no tighter than the standard character spacing value.

5. The device of claim 1, wherein the spacing engine is to apply character spacing to the text column to average the character spacing at sub-pixel granularity for a text line across the allocated width to improve aesthetics and readability.

6. The device of claim 1, wherein the rendering engine is provided by web browser client based on Java Script.

7. The device of claim 1, wherein the text column s sourced from a Portable Document Format (PDF) and rendered on-screen for HyperText Markup Language (HTML) display.

8. The device of claim 1, wherein the text column is rendered on-screen for a print-preview.

9. The device of claim 8, wherein the allocated width is taken from a column wid th of a source document and scaled based on a zoom level used in the print-preview interface.

10. The device of claim 1, wherein the rendering engine is to divide the text column into a plurality of lines of text to disable automatic reflowing of text and ensure that line breaks of the text column match the source document line breaks.

11. A method, comprising:
rendering off-screen, by a rendering en gin a text column having an allocated width identified from a source document;
adjusting, by a spacing engine, character spacing of the text column to identify a loosest value of character spacing to fit the text column into the allocated width without causing the text column to experience a height increase due to introduction of an additional line break caused by a text line exceeding the allocated width.

12. The method of claim 11, further comprising:
rendering the text column at a default character spacing;
tightening character spacing by an increment;
rendering the text column for the tightened character spacing;
checking the column height of the off-screen text column for a given increment and repeating, until the character, spacing reaches a lower limit, and
assigning the character spacing as the loosest value that results in the shortest column height, in response to the column height experiencing a reduction.

13. The method of claim 11, further comprising:
rendering the text column at a default character spacing;
tightening character spacing by an increment;
rendering the text column for the tightened character spacing;
checking the column height of the off-screen text column for a given in rement and repeating, until the character spacing reaches a lower limit;
loosening the character spacing by the increment, in response to the column height failing to experience a reduction, until the text column height experiences an increase; and
assigning the character spacing as the loosest value prior to the text column height experiencing the increase.

14. A non-transitory machine-readable storage medium encoded with instructions executable by a computing system that, when executed, cause the computing system to:
render off-screen, by a rendering engine, a text column on a line-by-line basis according to a plurality of text lines fitting within an allocated width, wherein the text column is to experience a height increase in response to introduction of an additional line break caused by a given text line exceeding the allocated width; and
adjust, by a spacing engine, character spacing of a given text line to identify a loosest value of character spacing to fit the text line into the allocated width without introducing an additional line break.

15. The storage medium of claim 14, further comprising instructions that cause the computing system to divide the text column into the plurality of text lines, where a given text line is treated as a HyperTexMarkup Language (HTML) container set to full justification.
